(19) United States
(12) Patent Application Publication
(10) Pub. No.: US 2023/0324755 A1
(43) Pub. Date: Oct. 12, 2023

(54) HIGH COLORATION SPEED SOLID-STATE ELECTROCHROMIC ELEMENT AND DEVICE

(71) Applicant: NITTO DENKO CORPORATION, Ibaraki-shi, Osaka (JP)

(72) Inventor: Liping Ma, San Diego, CA (US)

(73) Assignee: NITTO DENKO CORPORATION, Ibaraki-shi, Osaka (JP)

(21) Appl. No.: 18/021,624

(22) PCT Filed: Aug. 16, 2021
(86) PCT No.: PCT/US2021/046131

§ 371 Date: Feb. 16, 2023

Related U.S. Application Data
(60) Provisional application No. 63/067,192, filed on Aug. 18, 2020.

(51) Int. Cl. G02F 1/163; G02F 1/1524

(52) U.S. Cl. CPC G02F 1/1524; G02F 1/163; G02F 2001/1502

(57) ABSTRACT

The present disclosure relates to electrochromic electrochromic elements and devices with high coloration/switching speeds. The high coloration speed electrochromic devices include an insulating layer (16), comprising an electrically insulating material with a dielectric constant of at least 10, and at least one electrochromic material (14, 18) having one or more optical properties that may be changed upon application of an electric potential. Upon provision of an electric potential above a threshold, electrons and holes may be injected into the electrochromic material and blocked by the insulating layer, resulting in an accumulation of the electrons and holes in their respective electrochromic material, which results in a change to the one or more optical properties of the electrochromic material in less than 10 seconds. An opposite electric potential may be provided to reverse the change in the one or more optical properties.

### CROSS-REFERENCE TO RELATED APPLICATIONS

This application claims the benefit of U.S. Provisional Application No. 63/067,192, filed Aug. 18, 2020, which is incorporated by reference in its entirety.

### FIELD

The present disclosure relates to electrochromic elements and devices comprising an insulating layer and electrochromic materials having one or more optical properties that may be changed from a first optical property state to a second optical property state upon application of an electric potential.

### BACKGROUND

Electrochromic coatings or materials may be used for several different purposes. One such purpose includes controlling the amount of light and heat passing through a window based on a user-controlled electrical potential that is applied to an electrochromic coating. An electrochromic coating or material may reduce the amount of energy necessary to heat or cool a room and may provide privacy. For example, a clear state of the electrochromic coating or material, having an optical transmission of about 60-80%, may be switched to a darkened state, having an optical transmission of between 0.1-10%, where the energy flow into the room is limited and additional privacy is provided. Due to large amounts of glass found in various types of windows, such as skylights, aircraft windows, automobile windows, and residential and commercial building windows, there may be energy savings provided by the use of an electrochromic coating or material on glass.

Despite the potential benefits which may be provided by an electrochromic coating or device, various issues make current electrochromic devices undesirable for certain applications. Many solid-state electrochromic elements suffer from electronic leakage leading to degraded optical properties (including slow switching speeds), increased deposition time and increased cost. Some conventional solid-state electrochromic devices require thick electrochromic layers, for example 1 µm, to achieve a low percent transmission (%T) in the ON-state/darken state. The need for thick layers to achieve low %T leads to increased material consumption, increased processing time and slower production speed which all lead to increased manufacturing costs. This increased manufacturing cost (about $100/m²), has limited the electrochromic window market to only commercial buildings. Reduction in electrochromic window glass cost with improved optical properties is key to expanding the market. Thus, there remains a need for further contributions in this area of technology.

### SUMMARY

Disclosed herein are electrochromic elements and devices, which may change from a first state to a second state upon application of an electric potential. The present disclosure also describes electrochromic elements and devices having a blocking layer that exhibits insulative properties which retain changes to the optical properties of electrochromic materials following application of the electric potential. Furthermore, the present disclosure relates to electrochromic elements and devices exhibiting high coloration speed/switching times, e.g., the time it takes the element to go from transparent to a darkened state or from a darkened state to a transparent state.

Some embodiments include an electrochromic element comprising: a first electrode layer, wherein the first electrode layer comprises a transparent conductive material; a first electrochromic layer in electrical communication with the first electrode layer, wherein the first electrochromic layer comprises a p-type or doped p-type electrochromic material; an insulating layer in electrical communication with the first electrochromic layer, wherein the insulating layer comprises a electrically insulating material with a dielectric constant (K) of at least 10; a second electrochromic layer in electrical communication with the insulating layer, wherein the second electrochromic layer comprises an n-type electrochromic material; and a second electrode layer in electrical communication with the second electrochromic layer, wherein the second electrode layer comprises a transparent conductive material. The doped p-type electrochromic material of the first electrochromic layer may comprise an inorganic oxide and a metal oxide. In some embodiments, the atomic ratio of the doped p-type electrochromic material may be 1 to 20% of an inorganic oxide to a metal oxide. In still other embodiments, the n-type electrochromic material of the second electrochromic layer may be doped. The doped n-type electrochromic material may comprise a metal oxide and an inorganic oxide selected from an aluminum oxide, silicon oxide or a titanium oxide. The atomic ratio of the n-type electrochromic material may be 1 to 20% of an inorganic oxide to a metal oxide. In some embodiments, the p-type electrochromic material comprises nickel oxide which may be doped. In some embodiments, the n-type electrochromic material comprises tungsten oxide which may be doped.

Some embodiments include an electrochromic device comprising: an electrochemical element described herein, wherein the element further comprises a power source, wherein the power source is in electrical communication with the first electrode layer and the second electrode layer to provide an electric potential to the device.

In addition, the present disclosure provides methods for the preparation of the electrochromic elements and devices described herein.

### BRIEF DESCRIPTION OF THE DRAWINGS

FIG. 1 is a schematic illustration of one embodiment of an electrochromic element.

FIG. 2 is a schematic illustration of one embodiment of an electrochromic device.

FIG. 3 is an illustration showing the electron drift through the solid-state electrolytic layer (Ta₂O₅) and accumulation of electrons and holes at the nickel oxide electrolytic interface of a conventional electrochromic device.

FIG. 4 is an illustration showing the electron blockage by a metal oxide insulating layer (AI₂O₃) allowing for the accumulation of electrons in the n-type electrochromic layer and holes in the p-type electrochromic layer in an electrochromic device with an insulating layer with a high band gap and a high conductance minimum band relative to the Fermi level.

FIG. 5 is an illustration showing the electron blockage by a metal nitride insulating layer (AIN) allowing for the accumulation of electrons in the n-type electrochromic layer and holes in the p-type electrochromic layer in an electrochromic device with an insulating layer with a high band gap and a low conductance minimum band relative to the Fermi level.

FIG. 6 is a schematic of the device used for coloration time testing.

FIG. 7 is a graphic illustration showing the coloration time of CE-1 and EC-1 as a function of normalized %T vs time.

FIG. 8 is a graphic illustration showing the coloration time of CE-2, CE-3 and EC-2 as a function of normalized %T vs time.

FIG. 9 is a graphic illustration showing the coloration time of EC-2 and EC-3 as a function of normalized %T vs time.

### DETAILED DESCRIPTION

As used herein, the term “transparent” includes a property in which the corresponding material transmits or allows light to pass through the material. In one aspect, the transmittance of light through the transparent material may be about 50-100%, such as at least about 50%, at least about 60%, at least about 70%, at least about 80%, at least about 90%, at least about 95%, at least about 99%, about 50-60%, about 60-70%, about 70-80%, about 80-90%, about 90-95%, or about 95%-99%.

The term “light” as used herein includes light in a wavelength region targeted by an electrochromic element or device. For example, when the electrochromic element or device is used as a filter of an image pickup apparatus for a visible light region, light in the visible light region is targeted, and when the electrochromic element or device is used as a filter of an image pickup apparatus for an infrared region, light in the infrared region is targeted.

The term “darkness efficiency” as used herein includes the efficiency of the electrochromic element’s/device’s optical modulation ratio per unit of the electrochromic layer thickness represented by the following formula:

$$\text{Darkness efficiency =} \frac{T \% \left(O F F - s t a t e\right) / T \% \left(O N - s t a t e\right)}{E C - l a y e r t h i c k n e s s \left(n m\right)}$$

wherein T% is the transmittance percentage in the off-state (clear state) and the on-state (dark state) and the EC layer thickness is the thickness of the electrochromic stack in nm.

The term “band gap” (energy gap) as used herein has its ordinary meaning in the art and a person of ordinary skill in the art would recognize the term as including the energy required, measured in electron volts (eV), to promote a bound valence electron to become a conductive electron free to move within a solid layer. The conductive electron may serve as a charge carrier to conduct electrical current.

The term “coloration speed,” “coloration time,” “switching speed,” or “switching time,” which may be used interchangeably throughout this present application, as used herein, refers to the time the electrochromic element or device requires to decrease the transmittance of relative white light by 90%, or the time required to increase the relative white light by 90% under applied voltage (Off/On=10).

Use of the term “may” or “may be” should be construed as shorthand for “is” or “is not” or, alternatively, “does” or “does not” or “will” or “will not,” etc. For example, the statement “the device may comprise a protection layer” should be interpreted as, for example, “In some embodiments, the device comprises a protection layer,” or “In some embodiments, the device does not comprise a protection layer.”

The present disclosure generally relates to electrochromic elements and devices. More particularly the present disclosure relates to high coloration speed electrochromic elements and devices. The electrochromic elements and devices herein include at least one electrochromic element having one or more optical properties, such as transparency, absorption, or transmittance, that may be changed from a first state to a second state upon application of an electric potential. More particularly, but not exclusively, the present disclosure relates to electrochromic elements and devices comprising ultrathin layers, exhibiting improved on- and off-state switching speeds following application of the electric potential.

Generally, an electrochromic element comprises a first electrode and a second electrode. One or more blocking (or insulating) layers and one or more electrochromic layers may be disposed between the first electrode and the second electrode. Additional layers, such as a protection layer, may also be present in some embodiments of the electrochromic elements and devices disclosed herein.

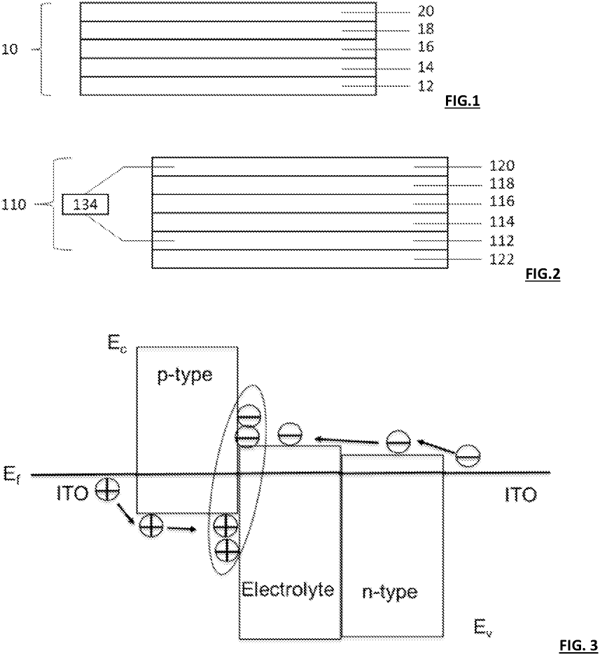

There are many potential configurations for the electrochromic element. One potentially useful configuration is depicted in FIG. 1. An electrochromic element, such as electrochromic element 10 in FIG. 1, comprises (e.g., in the order depicted, from bottom to top): a first electrode layer 12, which is a conductive layer; a first electrochromic layer 14 comprising a p-type or doped p-type electrochromic material; an insulating layer 16, which comprises an electrically insulative material or composite; a second electrochromic layer 18, comprising a n-type electrochromic material; and a second electrode layer 20, which is a conductive material. In some embodiments, the layers of the electrochromic element are in electrical and optical communication with one another. In some embodiments, the electrochromic layers of the electrochromic element may change from a first state (clear or transparent) to a second state (colored or darkened). In some embodiments, the electrically insulating material of the insulating layer 16, comprises a material or composite with a dielectric constant (K) of at least 10.

In some embodiments, the recited layers of the element are disposed in the recited order from bottom to top. In some embodiments, the recited layers of the electrochromic element are contacting one another in that order from bottom to top. Alternative arrangements of the layers of the electrochromic element are also contemplated.

The first electrode layer may optionally be in direct contact with the first electrochromic layer. The first electrochromic layer may optionally be in direct contact with the insulating layer. The insulating layer may optionally be in direct contact with the second electrochromic layer. The second electrochromic layer may optionally be in direct contact with the second electrode layer.

In some embodiments, first electrode layer is in direct contact with the first electrochromic layer and the first electrochromic layer is in direct contact with the insulating layer. In some embodiments, first electrode layer is in direct contact with the first electrochromic layer and the insulating layer is in direct contact with the second electrochromic layer. In some embodiments, first electrode layer is in direct contact with the first electrochromic layer and the second electrochromic layer is in direct contact with the second electrode layer.

In some embodiments, the first electrochromic layer is in direct contact with the insulating layer and the insulating layer is in direct contact with the second electrochromic layer. In some embodiments, the first electrochromic layer is in direct contact with the insulating layer and the second electrochromic layer is in direct contact with the second electrode layer.

In some embodiments, the insulating layer is in direct contact with the second electrochromic layer and the second electrochromic layer is in direct contact with the second electrode layer.

In some embodiments, the first electrochromic layer is in direct contact with the insulating layer, the insulating layer is in direct contact with the second electrochromic layer, and the second electrochromic layer is in direct contact with the second electrode layer.

In some embodiments, first electrode layer is in direct contact with the first electrochromic layer, the insulating layer is in direct contact with the second electrochromic layer, and the second electrochromic layer is in direct contact with the second electrode layer.

In some embodiments, first electrode layer is in direct contact with the first electrochromic layer, the first electrochromic layer is in direct contact with the insulating layer, and the second electrochromic layer is in direct contact with the second electrode layer.

In some embodiments, first electrode layer is in direct contact with the first electrochromic layer, the first electrochromic layer is in direct contact with the insulating layer, and the insulating layer is in direct contact with the second electrochromic layer.

In some embodiments, first electrode layer is in direct contact with the first electrochromic layer, the first electrochromic layer is in direct contact with the insulating layer, the insulating layer is in direct contact with the second electrochromic layer, and the second electrochromic layer is in direct contact with the second electrode layer.

Generally, an electrochromic device comprises the electrochromic element described above, or elsewhere herein, and a power source in electrical communication with the first electrode and the second electrode, to provide an electric potential to the electrochromic device.

There are many potential configurations for the electrochromic device. One potentially useful configuration is depicted in FIG. 2. In FIG. 2, an electrochromic device, such as device 110, comprises (e.g., in the order depicted): a first electrode layer 112, which is a conductive layer; a first electrochromic layer 114, comprising a p-type or doped p-type electrochromic material; an insulating layer 116, which comprises an electrically insulative material or composite; a second electrochromic layer 118, comprising a n-type electrochromic material; a second electrode layer 120, which is a conductive material; and a power source, such as power source 134, which is in electrical communication with the first electrode and the second electrode. In some embodiments, the electrically insulating material of the insulating layer 116, comprises a material or composite with a dielectric constant (K) of at least 10. In some embodiments, the layers of the electrochromic device are in electrical and optical communication with one another. In some embodiments, the electrochromic layers of the electrochromic device may change from a first state (clear or transparent) to a second state (colored or darkened).

In some embodiments, the layers of the device are disposed in the recited order from bottom to top. In some embodiments, the layers of the electrochromic device are contacting one another in that order from bottom to top. In some embodiments, the layers of the device are contacting one another in that order from top to bottom. Alternative arrangements of the layers of the electrochromic device are also contemplated.

The electrochromic elements and devices described herein comprise an electrode on, or adjacent to, the top and the bottom of the various electrochromic element or device layers. In some embodiments, the electrodes (“electrodes,” “the electrodes,” or a similar phrase is used as shorthand herein for “first electrode and/or second electrode”) may be formed on a bonding layer and/or a substrate. The electrodes may comprise a transparent material, which may also be conductive. When one or more of the electrodes are transparent, light and energy may be efficiently transmitted to the inner layers of the element or device and may interact with the electrochromic materials and other layers within the element or device.

In some embodiments, the electrochromic elements and devices disclosed herein comprise a first electrode layer and a second electrode layer. The first electrode and the second electrode may be defined in their entirety by the electrode(s) found in these layers, or it is possible that the electrodes of these layers only partially define these layers. In some embodiments, the electrodes of these layers may be formed on a bonding layer and/or substrate. In some embodiments, the remainder of the electrode layers, wherein the electrodes only partially define these layers, may be formed of a transparent material. In some examples, when one or more of the electrodes and layers are transparent, light may be efficiently taken in from the outside of layers to interact with the electrochromic material of the electrochromic element and enables optical modulation of the electrochromic material on emitted light.

In some examples, the electrodes may comprise a transparent conductive oxide, dispersed carbon nanotubes on a transparent substrate, partly arranging metal wires on a transparent substrate, or combinations thereof. In some embodiments, the electrodes may be formed from a transparent conductive oxide material having good transmissivity and conductivity, such as tin-doped indium oxide (also called indium tin oxide, or ITO), zinc oxide, gallium-doped zinc oxide (GZO), indium zinc oxide (IZO), aluminum-doped zinc oxide (AZO), tin oxide, antimony-doped tin oxide (ATO), fluorine-doped tin oxide (FTO), niobium-doped titanium oxide (TNO), a conductive polymer material, or a material containing Ag, Ag nanoparticles, carbon nanotubes or graphene. Of the transparent conductive oxide materials identified above, FTO may be selected for heat resistance, reduction resistance, and conductivity and ITO may be selected for conductivity and transparency. In the event a porous electrode is formed and calcined, then the transparent conductive oxide, if used, preferably has high heat resistance. One or more of the electrodes may contain one of these materials, or one or more of the electrodes may have a multi-layer structure containing a plurality of these materials. In an alternative form, one or more of the electrodes may be formed from a reflective material such as a Group 10 or 11 metal, non-limiting examples of which include Au, Ag, and/or Pt. Forms in which the reflective material is a Group 13 metal, such as aluminum (Al) are also possible.

In some embodiments, the first electrode is indium tin oxide. In some examples, the thickness of the first electrode (e.g., an ITO electrode) is about 10 nm to about 300 nm, about 10-12 nm, about 12-14 nm, about 14-16 nm, about 16-18 nm, about 18-20 nm, about 20-22 nm, about 22-24 nm, about 24-26 nm, about 26-28 nm, about 28-30 nm, about 30-35 nm, about 35-40 nm, about 40-50 nm, about 50-60 nm, about 60-70 nm, about 70-80 nm, about 80-90 nm, about 90-100 nm, about 100-110 nm, about 110-120 nm, about 120-130 nm, about 130-140 nm, about 140-150 nm, about 150-160 nm, about 160-170 nm, about 170-180 nm, about 180-190 nm, about 190-200 nm, about 200-210 nm, about 210-220 nm, about 220-230 nm, about 230-240 nm, about 240-250 nm, about 250-260 nm, about 260-270 nm, about 270-280 nm, about 280-290 nm, about 290-300 nm, about 75-85 nm, about 15-25 nm, about 1-50 nm, about 50-100 nm, about 100-150 nm, about 80 nm, about 20 nm, about 185 nm, or any thickness in a range bounded by any of these values.

In some embodiments, the second electrode is indium tin oxide. In some examples, the thickness of the second electrode (e.g., an ITO electrode) is about 10 nm to about 150 nm, about 10-12 nm, about 12-14 nm, about 14-16 nm, about 16-18 nm, about 18-20 nm, about 20-22 nm, about 22-24 nm, about 24-26 nm, about 26-28 nm, about 28-30 nm, about 30-35 nm, about 35-40 nm, about 40-50 nm, about 50-60 nm, about 60-70 nm, about 70-80 nm, about 80-90 nm, about 90-100 nm, about 100-110 nm, about 110-120 nm, about 120-130 nm, about 130-140 nm, about 140-150 nm, about 15-25 nm, about 1-50 nm, about 50-100 nm, about 100-150 nm, about 80 nm, about 20 nm, or any thickness in a range bounded by any of these values.

Some embodiments include electrochromic elements or electrochromic devices comprising at least two electrochromic layers. The electrochromic layers of the elements and devices described herein may comprise electrochromic materials containing charge sensitive materials. In some embodiments, the electrochromic layers of the electrochromic element or device comprise one or more optical properties that may change from a first state (clear or transparent) to a second state (colored or darkened) upon the application of an electric potential. In some embodiments, the electrochromic material of the first electrochromic layer may include doped p-type electrochromic materials. As used herein, the term “p-type electrochromic material” refers to a material in which its Fermi energy level (E_{f}) is closer to the valence band energy level (Eᵥ) than its conductance band energy level (E_{c}). As used herein the term “doped p-type electrochromic material” refers to a p-type electrochromic material doped with an inorganic oxide selected from aluminum oxide or silicon oxide. In some embodiments, the electrochromic material of the second electrochromic layer may include n-type electrochromic materials. The second electrochromic layer may further comprise a doped n-type electrochromic material. The dopant of the doped n-type electrochromic material may comprise an inorganic oxide selected from aluminum oxide, silicon oxide or titanium oxide. As used herein, the term “n-type electrochromic material” refers to a material in which its Fermi energy level (E_{f}) is closer to the conductance band energy level (E_{c}) than its valance band energy level (Eᵥ).

Table 1 illustrates some electrochromic materials’ E_{c}, Eᵥ, and E_{f}. This table is only for illustrative purposes and in no way is intended to limit which electrochromic materials that may be used in the current electrochromic elements and devices.

TABLE 1

| | | | | | |
|---|---|---|---|---|---|
| | MoO₃ | V₂O₅ | WO₃ | Ta₂O₅ | NiO |
| E_{c} (eV) | -6.7 | -6.7 | -6.5 | -4.03 | -2.1 |
| Eᵥ (eV) | -9.7 | -9.5 | -9.8 | -7.93 | -5.3 |
| E_{f} (eV) | -6.9 | -7.0 | -6.7 | -4.45 | -4.7 |
| Material Type | n-type | n-type | n-type | n-type | p-type |

In some embodiments, the first electrochromic layer may comprise a p-type electrochromic material. In some embodiments, the first electrochromic layer may comprise a doped p-type electrochromic material. It is believed that the doping of a p-type electrochromic material (e.g., NiO) either changes the band gap or forms a state within the band gap which may promote hole injections from the transparent conductive material of the first electrode layer (anode) into the p-type electrochromic material. The injection of holes into the p-type electrochromic material significantly enhances the oxidation of the p-type electrochromic material causing a transformation from a first state (transparent) to a second state (darkened). In some embodiments, the p-type electrochromic material may comprise an anodic material and at least one inorganic oxide material. The term “anodic electrochromic material” as used herein means a material that undergoes changes in optical properties by an oxidation reaction thereof in which electrons are removed from the material. In some embodiments, the p-type (anodic electrochromic) material may be, for example nickel oxide (NiO), iridium(IV) oxide (IrO₂), chromium oxide (Cr₂O₅), manganese dioxide (MnO₂), iron oxide (FeO₂), and cobalt(II) peroxide (CoO₂). In some embodiments, the p-type electrochromic material may comprise nickel oxide. In some embodiments the dopant inorganic material may comprise a trivalent cation. Examples of trivalent cations that may be used as the inorganic doping material may include, but are not limited to, aluminum (III) (Al³⁺), boron (B³⁺), chromium (Cr³⁺), or iron (III) (Fe³⁺). It is believed that the doping of nickel (II) oxide (Ni²⁺) with a trivalent cation blocks the formation of Ni³⁺ which may improve the electrochemical performance of nickel (II) oxide. It is further believed that this enhancement of the NiO electrochemical performance leads to faster oxidation rates when a positive electrical potential is applied across the layer and faster reduction rate when a negative electrical potential is applied. In other embodiments, the dopant inorganic material may comprise silicon (Si), vanadium (V), or titanium (Ti).

The atomic ratio of the dopant inorganic material to the metal oxide (e.g., NiO) may be between about 0.01 to 0.2, about 0.01-0.05, about 0.05-0.1, about 0.1-0.15, about 0.15-0.2, or about any ratio in a range bounded by any of these values. In some embodiments, the atomic ratio of dopant inorganic material to metal oxide may be 0.01. In other embodiments the atomic ratio of dopant inorganic material to metal oxide may be 0.05. In still other embodiments, the atomic ratio of dopant inorganic material to metal oxide may be 0.1. In other embodiments, the atomic ratio of dopant inorganic material to metal oxide may be 0.15. In some embodiments, the atomic ratio of dopant inorganic material to metal oxide may be 0.2.

The first electrochromic layer (e.g., a layer comprising a metal oxide or a doped metal oxide compound from the paragraph above) may have any suitable thickness, such as about 40-500 nm, about 40-50 nm, about 50-60 nm, about 60-70 nm, about 70-80 nm, about 80-90 nm, about 90-100 nm, about 100-110 nm, about 110-120 nm, about 120-130 nm, about 130-140 nm, about 140-150 nm, about 150-160 nm, about 160-170 nm, about 170-180 nm, about 180-190 nm, about 190-200 nm, about 200-210 nm, about 210-220 nm, about 220-230 nm, about 230-240 nm, about 240-250 nm, about 250-260 nm, about 260-270 nm, about 270-280 nm, about 280-290 nm, about 290-300 nm, about 300-350 nm, about 350-400 nm, about 400-450 nm, about 450-500 nm, about 80-100 nm, about 100-125 nm, about 125-150 nm, about 0.1-50 nm, about 50-100 nm, about 100-150 nm, about 0.1-60 nm, about 60-120 nm, about 120-180 nm, about 0.1-100 nm, about 100-300 nm, about 200-400 nm, about 300-500 nm, about 60 nm, about 80 nm, about 100 nm, about 125 nm, or about 150 nm, or any thickness in a range bounded by any of these values, although other variations are contemplated.

The first electrochromic layer comprising the electrochromic material may be fixed to the first electrode layer. The different options for fixing the first electrochromic layer are possible because in this electrochromic layer, at the time of the adjustment of charge imbalance, charge exchange between the electrodes needs only to occur by electron or hole movement through the layers and not by physical movement of the layers themselves.

In some embodiments, the electrochromic element comprises a second electrochromic layer. In some embodiments, the second electrochromic material may include an n-type electrochromic material as discussed above. N-type electrochromic materials allow electrons to be injected from the transparent conductive material of the second electrode layer (cathode). The injection of electrons into the n-type electrochromic material enhances the reduction of the n-type electrochromic material resulting in transformation of the material from a first optical state (transparent) to a second optical state (dark). In some embodiments, the n-type electrochromic materials may comprise cathodic materials. The term “cathodic electrochromic material” as used herein means a material that undergoes changes in optical properties by a reduction reaction thereof in which electrons are given to the material. In other embodiments, the second electrochromic material may comprise a doped n-type electrochromic material. In cases where the second electrochromic material is a doped n-type electrochromic material, the dopant may be an inorganic oxide material. The dopant inorganic oxide material may be selected from aluminum oxide (Al₂O₃), silicon oxide (SiO₂), titanium oxide (TiO₂), or vanadium oxide (V₂O₅).

Non-limiting examples of cathodic electrochromic materials include tungsten oxide (WO_{3- x}, where x is 0 ≤ x ≤1), titanium oxide (TiO₂), niobium oxide (Nb₂O₅), molybdenum (VI) oxide (MoO₃), tantalum(V) oxide (Ta₂O₅), and vanadium oxide (V₂O₅). In some embodiments, the second electrochromic layer comprises tungsten oxide (WO₃). In other embodiments, the second electrochromic layer comprises aluminum-tungsten oxide (Al—W—O). In still other embodiments, the second electrochromic layer may comprise silicon-tungsten oxide (Si—W—O). In still other embodiments, the second electrochromic layer may comprise titanium-tungsten oxide (Ti—W—O). In some embodiments, the second electrochromic layer comprises undoped WO₃.

The second electrochromic layer (e.g., comprising WO₃, WO₃₋ₓ, where x is 0 ≤ x ≤1, another metal oxide compound, doped WO₃₋ₓ or another doped metal oxide compound described in the paragraph above) may have any suitable thickness, such as about 100-500 nm, about 100-110 nm, about 110-120 nm, about 120-130 nm, about 130-140 nm, about 140-150 nm, about 150-160 nm, about 160-170 nm, about 170-180 nm, about 180-190 nm, about 190-200 nm, about 200-210 nm, about 210-220 nm, about 220-230 nm, about 230-240 nm, about 240-250 nm, about 250-260 nm, about 260-270 nm, about 270-280 nm, about 280-290 nm, about 290-300 nm, about 300-310 nm, about 310-320 nm, about 320-330 nm, about 330-340 nm, about 340-350 nm, about 350-360 nm, about 360-370 nm, about 370-380 nm, about 380-390 nm, about 390-400 nm, about 400-410 nm, about 410-420 nm, about 420-430 nm, about 430-440 nm, about 440-450 nm, about 450-460 nm, about 460-470 nm, about 470-480 nm, about 480-490 nm, about 490-500 nm, about 100-300 nm, about 200-400 nm, about 300-500 nm, about 150-250 nm, about 250-350 nm, about 350-450 nm, about 100 nm, about 150 nm, about 200 nm, about 250 nm, about 300 nm, about 350 nm, about 400 nm, or any thickness in a range bounded by any of these values, although other variations are contemplated. Of particular interest for the thickness of the second electrochromic layer are 200 nm and 400 nm thick layers ±10 nm.

In some embodiments, the second electrochromic layer comprising the electrochromic material may be fixed to the second electrode layer. The different options for fixing the second electrochromic layer are possible because in this layer, at the time of the adjustment of charge imbalance, charge exchange between the electrodes needs only to occur by electron or hole movement through the layers and not by physical movement of the layers themselves. Non-limiting methods of fixing the second electrochromic layer involve, for example, bonding the electrochromic material to the insulating layer through a functional group in a molecule of the electrochromic material, causing the insulating material to retain the electrochromic material in a comprehensive manner (e.g., in a film state) through the utilization of a force, such as an electrostatic interaction, or causing the electrochromic material to physically adsorb to the insulative material of the insulating layer. A method involving chemically bonding a low-molecular weight organic compound serving as the electrochromic material to a porous insulative material through a functional group thereof, or a method involving forming a high-molecular weight compound serving as the electrochromic material on the insulative material may be used when a quick reaction of the electrochromic material is desired. The former method may include fixing the low-molecular weight organic compound serving as the electrochromic material onto a fine particle oxide electrode, such as aluminum oxide, titanium oxide, zinc oxide, or tin oxide, through a functional group, such as an acid group (e.g., a phosphoric acid group or a carboxylic acid group). The latter method is, for example, a method involving polymerizing and forming a viologen polymer on an insulative material and may include electrolytic polymerization. Similar methods are contemplated for fixing the first electrochromic layer to the first electrode and to the insulating layer.

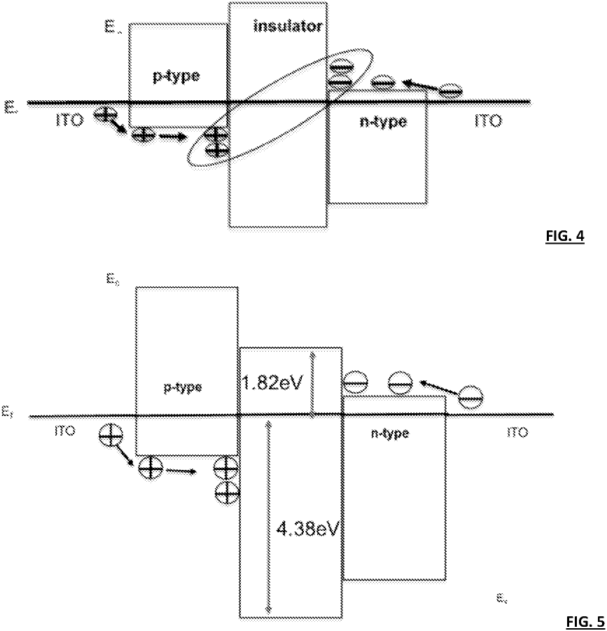

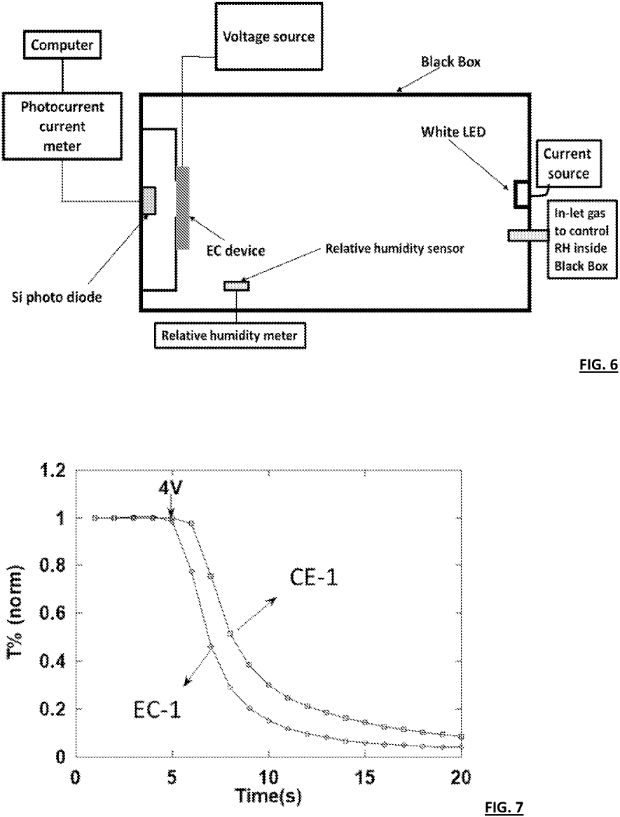

In some embodiments, the electrochromic elements and devices described herein comprise an insulating layer. In some embodiments, the insulating layer comprises an electrically insulating material characterized by a relative dielectric constant (k) of at least 10 (e.g., 15 (yttrium oxide (Y₂O₃)), 25 (hafnium oxide (HfO₂)), 25 (Zirconium oxide (ZrO₂)), and/or ~500 (barium titanate (BaTiO₃))). In other embodiments, the insulating layer comprises an electrically insulating material characterized by a relative dielectric constant (k) of at least 15. In still other embodiments, the insulating layer comprises an electrically insulating material characterized by a relative dielectric constant (k) of at least 20. In the illustrated form (FIGS. 1 and 2), the electrochromic material of the first electrochromic layer is isolated from the electrochromic material of the second electrochromic layer by the insulating layer. In some embodiments, the insulating layer blocks electronic charges (e.g., electrons and holes) from moving through the electrochromic elements or devices from one electrode to the other, while retaining the injected electrons from the cathode within the electrochromic material of the second electrochromic layer and confining the injected holes from the anode within the electrochromic material of the first electrochromic layer, thus resulting in the coloration or darkening of the electrochromic layers. FIG. 3 illustrates the electron drift of the insulating material (Ta₂O₅) with a very low conductance band, relative to the Fermi energy level, thus allowing electrons to penetrate the insulating material. FIG. 4 illustrates the electron blocking of the insulating material (Al₂O₃) with a high conductance band, relative to the Fermi energy level. FIG. 5 illustrates electron blocking of the insulating material (AIN) with a low conductance band, relative to the Fermi energy level. In some embodiments, the insulating layer may reduce or prevent charge leakage between the first and second electrochromic layers. In some embodiments, the insulating layer may increase coloration efficiency. Further, the first electrode layer may also be electrically isolated or separated from the second electrochromic material layer by the insulating layer, which includes an electrically insulative material. The term “electrically insulative” refers to the reduced transmissivity of the layer to electrons and/or holes. In one form, the electrical isolation or separation between these layers may result from increased resistivity within the insulating layer. In addition, it should be appreciated that the first electrode may be in electrical communication with the first electrochromic layer, which may be in electrical communication with the insulating layer, which may be in electrical communication with the second electrochromic layer, which may be in electrical communication with the second electrode layer. As indicated above, the insulating layer may include one or more electrically insulative materials, including inorganic and/or organic materials, which exhibit electrically insulative properties. It is believed that the electrically insulative properties of the insulating layer comes from the materials’ high dielectric constant (k) (the ability of the material to insulate charges from each other, or in other words, the ability of the material to stabilize charges). It is believed that the electrically insulative properties of the insulating layer comes from materials with a dielectric constant (k) of at least 10. It is believed that the coloration/switching speed is exponentially proportional to the capacitance of the insulating layers thickness and dielectric constant (k). When the insulative material has a dielectric constant of at least 10 it results in higher charge storage within the p-type and n-type electrochromic material or composites. It is believed that this increase in the stored charge leads to enhanced reduction of the n-type electrochromic material resulting in a darker second state and enhanced oxidation of the p-type electrochromic materials, also resulting in a darker second state. It is further believed that the higher charge storage results in a lower light transmittance. It is the cumulative effect of blocking both the holes and the electrons from passing into the insulative layer and increasing the stored charge within the electrochromic layers’ materials, that allows for the use of ultrathin layers of first and second electrochromic layers and insulative layer within the electrochromic elements and devices of the present disclosure. However, if the insulating layer’s thickness is too thin, the current may leak through the layer, resulting in reduced coloration/switching speeds. Thus, there is a balance between the dielectric constant and the thickness of the insulating layer required for there to be increased coloration/switching speeds within the electrochromic element or device.

In some embodiments, the insulating layer may comprise oxide, nitride, and/or fluoride compounds. Some embodiments of the insulating layer comprise aluminum oxide (Al₂O₃), yttrium oxide (Y₂O₃), hafnium oxide (HfO₂), zirconium oxide (ZrO₂), titanium oxide (TiO₂), barium titanate (BaTiO₃), silicon nitride (Si₃N₄), aluminum nitride (AIN), and/or lithium fluoride. In some embodiments, the insulating layer comprises aluminum oxide, yttrium oxide, hafnium oxide, zirconium oxide or tantalum oxide. In another embodiment, the insulating layer comprises a stoichiometric metal oxide compound, such as Y₂O₃, HfO₂, TiO₂, or ZrO₂. In other embodiments, an insulating layer comprising non-stoichiometric metal oxide compounds are also contemplated. In some embodiments, the non-stochiometric metal oxide compounds may comprise a ferroelectric material. The ferroelectric material may be barium titanate (BaTiO₃). In some embodiments, the insulating layer may comprise aluminum oxide (Al₂O₃). In some embodiments, the insulating layer may comprise yttrium oxide (Y₂O₃). In some embodiments, the insulating layer may comprise hafnium oxide (HfO₂). In some embodiments, the insulating layer may comprise zirconium oxide (ZrO₂).

In some embodiments, wherein the insulating layer comprises a metal oxide compound, the metal oxide compound further comprises an inorganic doping material. In some embodiments, the inorganic doping material may be silicon oxide (SiO₂). In other embodiments, the inorganic doping material may be aluminum oxide (Al₂O₃). In still other embodiments, the inorganic doping material may be titanium oxide (TiO₂). In some embodiments, the atomic ratio of inorganic doping material to metal oxide (e.g. HfO₂) may be between about 0.01 to 0.2, about 0.01-0.05, about 0.05-0.1, about 0.1-0.15, about 0.15-0.2, or any value in a range bounded by any of these values. In some embodiments, the atomic ratio of dopant inorganic material to metal oxide may be 0.01. In other embodiments the atomic ratio of dopant inorganic material to metal oxide may be 0.05. In still other embodiments, the atomic ratio of dopant inorganic material to metal oxide may be 0.1. In other embodiments, the atomic ratio of dopant inorganic material to metal oxide may be 0.15. In still other embodiments, the atomic ratio of dopant inorganic material to metal oxide may be 0.2.

The insulating layer may have any suitable thickness, such as about 40 nm to about 150 nm, about 40-50 nm, about 50-60 nm, about 60-70 nm, about 70-80 nm, about 80-90 nm, about 90-100 nm, about 100-110 nm, about 110-120 nm, about 120-130 nm, about 130-140 nm, about 140-150 nm, about 60-65 nm, about 65-70 nm, about 70-75 nm, about 75-80 nm, about 80-85 nm, about 85-90 nm, about 60 nm, about 80 nm, about 100 nm, or any thickness in a range bounded by any of these values, although other variations are contemplated. In some embodiments, the insulating layer may have a thickness which is less than, equal to, and/or greater than the thickness of the first electrochromic layer or the second electrochromic layer. In some examples, the insulating layer comprises materials and/or structures that are effective in confining, on a selective basis, electrons and/or holes within the adjacent electrochromic layers. It is believed that confining the electrons and/or holes within their respective electrochromic layers may significantly increase the reduction and/or oxidation of the metal oxide electrochromic material leading to a lower percentage of transmittance (T%) at the second (darkened) state.

In some embodiments, the insulating layer may be effective for maintaining (in whole or in part) charges injected in the electrochromic materials of the adjacent electrochromic layers to be stored under a no bias condition; i.e., without continued application of an electric potential.

As detailed above, second electrochromic layer comprises an electrochromic material. In some embodiments, the electrochromic material may include an electrochromic compound and a matrix material. In one particular but non-limiting form, the electrochromic material includes a metal oxide such as WO₃₋ₓ, where x is 0 ≤ x ≤1. However, it should be appreciated that the electrochromic layers may include any electrochromic material or compound that changes optical transmittance and/or absorption when, for example, an insulating layer is present, it is in a charged-state that may be achieved by, for example, the charged injection from an electrode layer into the second electrochromic layer under an applied voltage pulse above a critical value.

In some forms, the electrochromic material may include both inorganic and/or organic materials. When an organic compound is included, it may be a low-molecular weight organic compound and/or a high-molecular weight organic compound. Each of these types of materials may be colored by the application of an electric potential as described herein. Non-limiting examples of high-molecular weight organic compounds of this type include those containing a pyridinium salt, and the compound may be, for example, a viologen-based high-molecular weight compound. In some embodiments, the electrochromic material may include a low-molecular weight organic compound. The electrochromic material comprises a compound that undergoes changes in optical properties, such as from a first state decolored form to a second state colored form, through an oxidation reaction (i.e., by giving up electrons) or a reduction reaction (i.e., by accepting electrons). In one or more forms, the electrochromic material includes one or more anodic electrochromic materials and/or one or more cathodic electrochromic materials.

Some embodiments may have the structure/composition of electrochromic element A, B, C, D, or E.

| | | | | | |
|---|---|---|---|---|---|
| Electrochromic Element | First Electrode | First Electrochromic layer | Insulating layer | Second Electrochromic layer | Second Electrode |
| A | ITO | Al (10%)—Ni—O | Si (10%)—Hf—O | WO₃ | ITO |
| B | ITO | NiO | ZrO₂ | WO₃ | ITO |
| C | ITO | NiO | Y₂O₃ | WO₃ | ITO |
| D | ITO | Al (10%)—Ni—O | ZrO₂ | WO₃ | ITO |
| E | ITO | Al (10%)—Ni—O | BaTiO₂ | WO₃ | ITO |

With respect to electrochromic element A, B, C, D, or E, in some embodiments, the first electrochromic layer has a thickness of about 60-120 nm. With respect to electrochromic element A, B, C, D, or E, in some embodiments, the insulating layer has a thickness of about 60-120 nm. With respect to electrochromic element A, B, C, D, or E, in some embodiments, the second electrochromic layer has a thickness of about 150-250 nm. With respect to electrochromic element A, B, C, D, or E, in some embodiments, the second electrode has a thickness of about 60-100 nm.

In some embodiments, the electrochromic element may be incorporated into a device. When the electrochromic element forms a device, the device may comprise a protection layer, such as protection layer 122 (See FIG. 2). In some embodiments, the protection layer may comprise a polymer or other material to protect the electrochromic device from moisture, oxidation, physical damage, etc. Any suitable protective layer may be selected.

It is contemplated that the electrochromic elements and devices herein could be used for a number of different purposes and applications. In one non-limiting form, for example, the electrochromic elements and devices herein could be used in a window member that includes a pair of transparent substrates with the electrochromic elements and devices described herein positioned between said transparent substrates. Owing to the presence of the electrochromic element or device of the present disclosure, the window member may adjust the quantity of light transmitted through the window member bearing the transparent substrates. In addition, the window member may include a frame which supports the electrochemical element or device of the current disclosure, and the window member may be used in an aircraft, an automobile, a house, a commercial building, or the like, just to provide a few possibilities. In some embodiments, the window member comprising the electrochemical element or device of the present disclosure may effect a difference in the transmission of light therethrough of at least 10%, at least 20%, at least 30%, at least 40%, at least 45%, at least 50%, at least 55%, at least 60%, at least 65%, at least 70%, at least 75%, at least 80%, at least 85%, at least 90%, at least 95%, or about 95%-100%, about 10-30%, about 30-50%, about 50-70%, about 70-90%, or about 90-100%, between the off- and on-state at a selected wavelength in the visible range of light.

In some embodiments, activation of (or turning on) the electrochromic materials of the first electrochromic layer and the second electrochromic layer involves injecting holes into the first electrochromic layer while electrons are injected into the second electrochromic layer as the second electrode is held at a ground potential and a positive voltage is applied to the first electrode. In some embodiments, the positive voltage (Vpp) may be from about 1 to about 5 volts, at least 12 volts when the positive read or operating voltage, Vdd, is about 5 volts, and from about 20 volts to about 25 volts, although other variations are contemplated. In order to deactivate (or turn off) the electrochromic material of the electrochromic layers, the second electrode may be held at a ground potential, and a negative voltage applied to the first electrode. Alternatively, both the first electrode may be held at a ground potential, and a positive voltage applied to the second electrode. In various embodiments, the negative voltage (-Vpp) may be, for example at least -1 volt, -2 volts, -4 volts, -5 volts, up to -12 volts (e.g., when the negative read or operating voltage (Vdd) is about -2 volts), or from about -20 volts to about -25 volts. A ground potential generally refers to a virtual ground potential or a voltage level of about 0 V.

While operation of the present disclosure has been described principally in connection with the electrochromic devices described herein, it is believed that the operating principles of the electrochromic devices and electrochromic elements described herein are the same. In FIG. 2, a voltage pulse is applied to the first electrode and the second electrode. Since the device is insulated under normal operation, the applied voltage pulse is only needed for switching states of the first electrochromic material of the first electrochromic layer and second electrochromic material of the second electrochromic layer. Further, as indicated above, electron and/or hole conduction may only occur upon application of a threshold voltage pulse necessary to push electrons and/or holes into or out of the electrochromic material of the electrochromic layers. Moreover, given that the device is insulated under normal operation and the electrochromic material of the electrochromic layers is insulated from the electrodes and/or holes, the leakage of charges into or out of the electrochromic material is reduced, minimized, or eliminated.

The insulating effect of the insulating/blocking layer of the present disclosure may provide a dielectric constant of at least 10 that may keep the electron[s] trapped therein as the “memory” effect (non-volatile), which reduces, minimizes and/or insures no power consumption under normal device operation unless a switching process is occurring. Similarly, this arrangement may reduce, minimize and/or eliminate the issue of leakage suffered in other forms of electrochromic devices. In addition, the insulative properties of the devices described herein allow the voltage applied from the power supply to the electrochromic material of electrochromic layers to be uniformly applied without a potential drop to the electrode, since the resistance of the device is much larger than the resistance of the electrode. Other forms of an electrochromic device may generally be highly conductive and, in applications for a larger area such as a window, the device has a much lower resistance and the electrode layer’s resistance may be comparable to or less than the device’s resistance. This may result in a drop across the electrode layer, which may cause non-uniformity in application of the power supply for applications of these devices in larger area applications. In contrast, as indicated above, it is believed the electrochromic elements and electrochromic devices of the present disclosure may be effective for minimizing, reducing or eliminating the occurrence of this issue.

In some embodiments of the present disclosure, the electrochromic material of the electrochromic layer may trap both electrons and holes. Once a voltage pulse is supplied to the two electrodes above a threshold value, electron injection from the cathode electrode into the electrochromic material of second electrochromic layer and hole injection from the anode into the first electrochromic layer, may occur due to the high dielectric constant (at least 10 or greater) of the insulating layer. The charges will be stored in the respective electrochromic layers due to the insulative effect provided by the insulating layer. The stored charges in the electrochromic material of electrochromic layers may cause a color change or a change in transmission/absorption. For example, it may cause a change from a first state that is clear to a second state that has high absorption (darkened). It is believed that the high dielectric constant material of the insulating layer allows for a faster storage of the respective charges in the electrochromic material which in turn leads to increased coloration or switching speeds within the electrochromic materials.

Deactivation of, or turning off of, the electrochromic material of first and the second electrochromic layers involves the inverse of the activation/turning on procedure. For example, if the electrochromic material of second electrochromic layer is activated/turned on by supplying a positive voltage to the first electrode, the deactivation/turning off operation involves supplying a negative voltage of about the same magnitude to the second electrode while the source electrode is held at a ground potential. Alternatively, if the electrochromic material of electrochromic layer is activated by supplying a negative voltage to the second electrode, the deactivation/turning off operation involves supplying a positive voltage of about the same magnitude to the control gate/gate electrode while the source electrode and drain electrode are held at a ground potential.

Some embodiments include a method for preparing an electrochromic device. In some embodiments, the method may comprise providing: a first electrode layer comprising a transparent conductive material; a first electrochromic layer comprising a doped p-type electrochromic material deposited upon and in physical and electrical communication with the first electrode layer; an insulating layer comprising an electrically insulating material, with a dielectric constant of at least 10, deposited upon and in physical and electrical communication with the first electrochromic layer; a second electrochromic layer comprising an n-type or doped n-type electrochromic material deposited upon and in physical and electrical communication with the insulating layer; and a second electrode layer comprising transparent conductive material deposited upon and in physical and electrical communication with the second electrochromic layer. Some embodiments include a second electrode layer having a nanostructure surface morphology. In some embodiments of the method, the electrochromic device is annealed at 300° C. for 5 to 30 minutes. One skilled in the art would understand that the deposition of the layers may be performed by any suitable method. However, for the high coloration/switching speed electrochromic device fabrication it is important that the system that is utilized for depositing of the materials maintains an inert environment (e.g., N₂ gas or other inert gas). It is also imperative that the device fabrication process is continuous without breaking the vacuum of the system. In some embodiments, the device may comprise a protection layer, such as protection layer 122 (See FIG. 2). In some embodiments, the protection layer may comprise a polymer or other material to protect the electrochromic device from moisture, oxidation, physical damage, etc. Any suitable protective layer may be selected.

In some embodiments, the method further comprises electrically connecting the transparent conductive material of the first electrode layer and the transparent conductive material of the second electrode layer to a power source, wherein the first electrode layer and the second electrode layer are in electrical communication. In still other embodiments, the method further comprises a tunneling layer disposed between the second electrode layer and the second electrochromic layer.

Some embodiments include a method for preparing an electrochromic device, wherein the method may further comprise encapsulating the device with an optically transparent encapsulation material. The optically transparent encapsulating material may be oxygen limiting or preventing, not allowing or greatly reducing the exposure to atmospheric oxygen. The choice of encapsulating material is not limiting, and any suitable encapsulating material may be selected.

### EMBODIMENTS

Embodiment 1 A high coloration speed solid-state electrochromic element comprising:
a first electrode layer, wherein the first electrode layer comprises a transparent conductive material;
a first electrochromic layer in electrical communication with the first electrode layer, wherein the first electrochromic layer comprises a p-type or doped p-type electrochromic material;
an insulating layer in electrical communication with the first electrochromic layer, wherein the insulating layer comprises an electrically insulative material or composite with a dielectric constant (k) of at least 10;
a second electrochromic layer in electrical communication with the insulating layer, wherein the second electrochromic layer comprises an n-type electrochromic material; and
a second electrode layer in electrical communication with the second electrochromic layer, wherein the second electrode layer comprises a transparent conductive material.

Embodiment 2 The high coloration speed solid-state electrochromic element of embodiment 1, wherein the doped p-type electrochromic material of the first electrochromic layer comprises a metal oxide and an inorganic oxide doping material.

Embodiment 3 The high coloration speed solid-state electrochromic element of embodiment 2, wherein the metal oxide is nickel oxide (NiO).

Embodiment 4 The high coloration speed solid-state electrochromic element of embodiment 2, wherein the inorganic oxide doping material comprises aluminum oxide (Al₂O₃), silicon oxide (SiO₂), titanium oxide (TiO₂) or vanadium oxide (V₂O₅).

Embodiment 5 The high coloration speed solid-state electrochromic element of embodiments 1, 2 3, or 4, wherein the atomic ratio of the doped p-type electrochromic materials is 1 to 20% of the inorganic oxide doping material to the metal oxide.

Embodiment 6 The high coloration speed solid-state electrochromic element of embodiments 1, 2, 3, or 4, wherein the atomic ratio of the doped p-type electrochromic materials is 5 to 10% of the inorganic oxide doping material to the metal oxide.

Embodiment 7 The high coloration speed solid-state electrochromic element of embodiment 1, wherein the electrically insulative composite comprises a metal oxide with a dielectric constant of at least 10, and at least one additional metal oxide or inorganic compound.

Embodiment 8 The high coloration speed solid-state electrochromic element of embodiments 1 or 7, wherein the metal oxide of the electrically insulating material comprising a with a dielectric constant of at least 10 comprises zirconium oxide (ZrO₂), hafnium oxide (HfO₂), or Yttrium oxide(Y₂O₃) or barium titanate (BaTiO₃).

Embodiment 9 The high coloration speed solid-state electrochromic element of embodiment 6, wherein the inorganic material comprises aluminum (Al) or silicon (Si), or titanium (Ti).

Embodiment 10 The high coloration speed solid-state electrochromic element of embodiment 1 or 7, wherein the electrically insulating composite comprises barium titanate (BaTiO₃).

Embodiment 11 The high coloration speed solid-state electrochromic element of embodiments 1 or 5, wherein the atomic ratio of the composite insulating material is 1 to 20% of the inorganic material to the metal oxide material.

Embodiment 12 The high coloration speed solid-state electrochromic element of embodiments 1, or 5, wherein the atomic ratio of the composite insulating material is 5 to 10% of the inorganic material to the material with a dielectric constant (k) of at least 10.

Embodiment 13 The high coloration speed solid-state electrochromic element of embodiments 1, 2, 3, 4, 5, 6, 7, 8, 9, or 10, wherein the insulating layer is about 10 — 100 nm thick.

Embodiment 14 The high coloration speed solid-state electrochromic element of embodiments 1, 2, 3, 4, 5, 6, 7, 8, 9, 10, or 11 wherein the insulating layer is 20-80 nm thick.

Embodiment 15 The high coloration speed solid-state electrochromic element of embodiments 1, 2, 3, 4, 5, 6, or 7, wherein the n-type electrochromic material of the second electrochromic layer comprises tungsten oxide (WO₃₋ₓ, where x is 0 ≤ × ≤1) or tungsten oxide doped with an additional inorganic material.

Embodiment 16 The high coloration speed solid-state electrochromic element of embodiments 15, where the atomic ratio of the additional inorganic material to tungsten oxide is 0 to 40%.

Embodiment 17 The high coloration speed solid-state electrochromic element of embodiments 1, 2, 3, 4, 5, 6, 7, 8, 9, 10, 11, 12, 13, 14, 15, or 16, wherein the transparent conductive material of the first electrode comprises indium tin oxide.

Embodiment 18 The high coloration speed solid-state electrochromic element of embodiments 1, 2, 3, 4, 5, 6, 7, 8, 9, 10, 11, 12, 13, 14, 15, 16, or 17, wherein the transparent conductive material of the second electrode comprises indium tin oxide.

Embodiment 19 The high coloration speed solid-state electrochromic element of embodiments 1, 2, 3, 4, 5, 6, 7, 8, 9, 10, 11, 12, 13, 14, 15, 16, 17, or 18, wherein the p-type electrochromic layer is 20 to 200 nm thick.

Embodiment 20 The high coloration speed solid-state electrochromic element of embodiments 1, 2, 3, 4, 5, 6, 7, 8, 9, 10, 11, 12, 13, 14, 15, 16, 17, 18, or 19, wherein the p-type electrochromic layer is 40 to 150 nm thick.

Embodiment 21 The high coloration speed solid-state electrochromic element of embodiments 1, 2, 3, 4, 5, 6, 7, 8, 9, 10, 11, 12, 13, 14, 15, 16, 17, 18, 19, or 20, wherein the p-type electrochromic layer is 60 to 100 nm thick.

Embodiment 22 The high coloration speed solid-state electrochromic element of embodiments 1, 2, 3, 4, 5, 6, 7, 8, 9, 10, 11, 12, 13, 14, 15, 16, 17, 18, 19, 20, or 21, wherein the n-type electrochromic layer is 50 to 400 nm thick.

Embodiment 23 The high coloration speed solid-state electrochromic element of embodiments 1, 2, 3, 4, 5, 6, 7, 8, 9, 10, 11, 12, 13, 14, 15, 16, 17, 18, 19, 20, 21, or 22, wherein the n-type electrochromic layer is 100 to 300 nm thick.

Embodiment 24 The high coloration speed solid-state electrochromic element of embodiment 23, wherein the n-type electrochromic layer is 180 to 220 nm thick.

Embodiment 25 The high coloration speed solid-state electrochromic element of embodiments 1, 2, 3, 4, 5, 6, 7, 8, 9, 10, 11, 12, 13, 14, 15, 16, 17, 18, 19, 20, 21, 22, 23, or 24, wherein the electrode layer is 20 to 400 nm thick.

Embodiment 26 The high coloration speed solid-state electrochromic element of embodiments 1, 2, 3, 4, 5, 6, 7, 8, 9, 10, 11, 12, 13, 14, 15, 16, 17, 18, 19, 20, 21, 22, 23, 24, or 25, wherein the electrode layer is 40 to 200 nm thick.

Embodiment 27 The high coloration speed solid-state electrochromic element of embodiments 1, 2, 3, 4, 5, 6, 7, 8, 9, 10, 11, 12, 13, 14, 15, 16, 17, 18, 19, 20, 21, 22, 23, 24, 25, or 26, wherein the electrode layer is 50 to 100 nm thick.

Embodiment 28 The high coloration speed solid-state electrochromic element of embodiment 27, wherein the electrode layer is 60 to 80 nm thick.

Embodiment 29 A high coloration speed solid-state electrochromic device comprising:

An electrochemical element of any one of embodiments 1-28, wherein the element further comprises a power source, wherein the power source is in electrical communication with the first electrode layer and the second electrode layer to provide an electric potential to the device.

Embodiment 30 The high coloration speed electrochromic device of embodiment 29, wherein at least one optical property of the electrochromic device may be changed from a first state to a second state upon application of an electric potential; and wherein the electrochromic device is structured so that the second state is maintained without continued application of the electric potential.

Embodiment 31 The high coloration speed solid-state electrochromic element of embodiment 30, wherein the electrical potential is a voltage of 2 to 6 volts.

Embodiment 32 The high coloration speed solid-state electrochromic element of embodiment 30, wherein the electrical potential is a voltage of 3 to 5 volts.

Embodiment 33 A method for preparing an electrochromic device comprising:
providing a first electrode layer, wherein the first electrode comprises a transparent conductive material;
providing a first electrochromic layer, wherein the first electrochromic layer comprises a p-type electrochromic material, deposited upon and electrical communication with the first electrode layer;
providing an insulating layer, wherein the insulating layer comprise an electrically insulating material deposited upon and in electrical communication with the first electrochromic layer;
providing a second electrochromic layer, wherein the second electrochromic layer comprises a n-type electrochromic material, deposited upon and in electrical communication with the insulating layer; and
providing a second electrode layer, wherein the second electrode layer comprises a transparent conductive material with a nanostructured surface morphology deposited upon and in electrical communication with the second electrochromic layer.

Embodiment 34 The method of embodiment 33, further comprising disposing a protective layer on first electrode layer, opposite the surface where the first electrochromic layer is disposed.

Embodiment 35 The method of embodiment 33, further comprising connecting a power source.

Embodiment 36 The method of embodiment 33, further comprising electrically connecting the transparent conductive material of the first electrode layer and the transparent conductive material of the second electrode layer to the power source, wherein the first electrode layer and the second electrode layer are in electrical communication.

### EXAMPLES

It should be appreciated that the following Examples are for illustration purposes and are not intended to be construed as limiting the subject matter disclosed in this document to only the embodiments disclosed in these examples.

### Preparing Electrochromic Device EC-1

A pre-learned patterned ITO-glass substrate (first electrode) was loaded onto a hybrid sputtering/thermal vacuum deposition chamber (Angstrom Engineering, Inc.) with the based vacuum pressure less than 4 × 10⁻⁶ torr. First, a 100 nm layer of a Al(10%)—Ni—O, doped p-type, electrochromic layer was deposited from an Al—Ni target under a working gas of Ar—O₂, where O₂ concentration was set at 30% with a deposition rate of 2 Å/s. Next, a 100 nm insulating layer of Si (10%)—Hf—O (100 nm) was deposited from a Si—Hf target under a working gas of Ar—O₂, where the O₂ concentration was set at 15% with a deposition rate of 3 Å/s. Next, a 200 nm layer of WO_{3-X} (where x is 0 ≤ × ≤1), the n-type electrochromic layer was deposited from a W target under a working gas of Ar—O₂, where O₂ concentration was set at 35% with a deposition rate of 3 Å/s. Next, the ITO electrode (second electrode/cathode) was deposited at a deposition rate of 1.5 Å/s. Electrical connections were connected between a power source (Tektronix, Inc., Beaverton, OR, USA, Kethley 2400 source meter) and switched electrical connections with the electrodes to enable selective application of potential to the first electrode (on) or to the bottom or second electrode (off). Post annealing was carried out at 300° C. for 30 minutes.

The devices of Examples EC-2, EC-3, EC-4, CE-1, CE-2 and CE-3 were made in a manner similar to that described above with respect to the device of Example EC-1, except as indicated in Table 2 below.

Devices of Examples EC-5 and EC-6 will be made in a manner similar to that described above with respect to the device of Example EC-1, except as indicated in Table 2 below.

TABLE 2

Electrochromic Devices

| | | | | | | |
|---|---|---|---|---|---|---|
| Example | Substrat e | First Electrode | First Electrochromic layer | Insulating layer | Second Electrochromic layer | Second Electrode |
| CE-1 | Glass | ITO | Al (10%)—Ni—O (100 nm) | Si (10%)—Al—O (80 nm) | WO₃ (200 nm) | ITO (80 nm) |
| CE-2 | Glass | ITO | NiO (100 nm) | Al₂O₃ (100 nm) | WO₃ (200 nm) | ITO (80 nm) |
| CE-3 | Glass | ITO | NiO (100 nm) | SiO₂ (80 nm) | WO₃ (200 nm) | ITO (80 nm) |
| EC-1 | Glass | ITO | Al (10%)—Ni—O (100 nm) | Si (10%)—Hf—O (100 nm) | WO₃ (200 nm) | ITO (80 nm) |
| EC-2 | Glass | ITO | NiO (100 nm) | ZrO₂ (100 nm) | WO₃ (200 nm) | ITO (80 nm) |
| EC-3 | Glass | ITO | NiO (100 nm) | ZrO₂ (100 nm) | WO₃ (200 nm) | ITO (80 nm) |
| EC-4 | Glass | ITO | NiO (80 nm) | Y₂O₃ (100 nm) | WO₃ (200 nm) | ITO (80 nm) |
| EC-5 Prophetic | Glass | ITO | Al (10%)—Ni—O (100 nm) | ZrO₂ (100 nm) | WO₃ (200 nm) | ITO (80 nm) |
| EC-6 Prophetic | Glass | ITO | Al (10%)—Ni—O (100 nm) | BaTiO₂ (100 nm) | WO₃ (200 nm) | ITO (80 nm) |

### Coloration Time

Coloration time was measured by using a measurement system like that illustrated in FIG. 6. Within a closed chamber, an electrochromic device is mounted in front of the Si photodiode. The Si photodiode operates as a sensor for a photocurrent meter (Filed Max II Laser Power Meter (RoHS), Coherent, Inc., Santa Clara, CA, USA). The meter is connected through a USB port to a computer for data collecting. At the opposite side of the chamber a white LED light is mounted within. The chamber is fitted with a gas inlet valve and a relative humidity sensor, which is connected to a relative humidity meter located outside the chamber, (AcuRite, 01083 M) to control for relative humidity within the chamber. The chamber atmosphere is adjusted to 40% relative humidity. For testing, an electrochromic device is mounted within the chamber. A constant current of 1 mA is applied to the white LED, such that the white LED shines a constant light on the surface of the electrochromic device mounted at the opposite end of the chamber. Once mounted and current is flowing through the white light a +4-volt voltage is applied to the electrochromic device through a 2400 Keithley Graphical Series Source meter (Tektronix, Inc. Beaverton. OR, USA) to activate it to an On-state (coloration) and the photocurrent and time is recorded by the computer. Next, a -4-volt voltage is applied to a device to deactivate it to an Off-state (transparent) and the photocurrent and time is recorded by the computer. Coloration times (c), the time required for an electrochromic device to darken from 90% transmittance to 10% transmittance was calculated by dividing time at 90% transparent (T_{clear}) by time at 10% transparent (T_{dark}). The results are listed in Table 3 below.

The coloration times for T_{clear} to T_{dark as} a function of time for the devices may be shown in the graphical representation. Where %T(norm) is calculated by

$$\frac{p h o t o c u r r e n t \left(t\right)}{p h o t o c u r r e n t \left(\text{clear state}\right)}$$

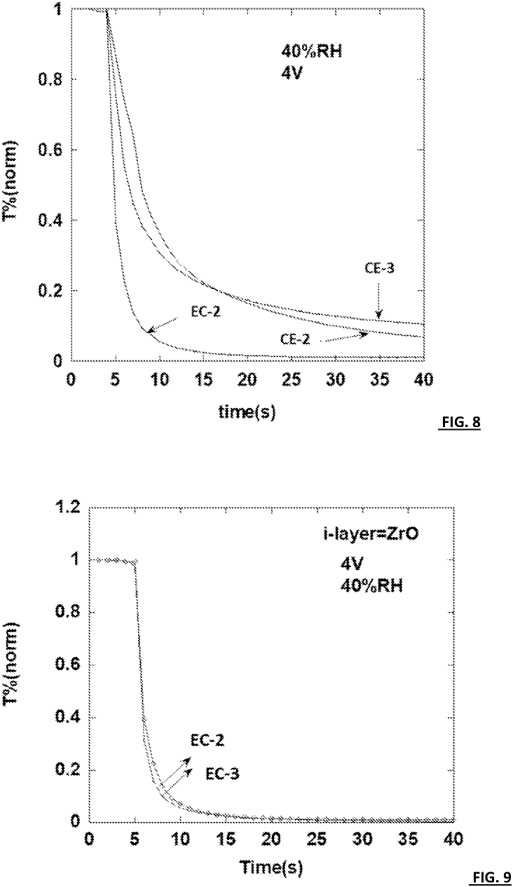

and plotted as a function of time. FIG. 7 illustrated the increase in coloration speed of device EC-1 (Si—Hf—O insulation layer) compared to CE-1, when the insulating layer (i-layer) comprises a material with a dielectric constant of at least 10 or greater (EC-1 i-layer k= 22.9, CE-1 k= 8.5). FIG. 8 illustrates the increase in coloration speed of device EC-2 compared to CE-2 and CE-3, when the i-layer comprises a material with a dielectric constant of at least 10 or greater (EC-2 i-layer k= 254, CE-2 k= 9 and CE-3 k= 3.9). FIG. 9 illustrates the effect of i-layer thickness (both EC-2 and EC-3 has ZrO₂ as the electrically insulating material for the i-layer) on coloration time wherein EC-2 has an i-layer thickness of 200 nm and EC-3 has an i-layer thickness of 400 nm.

TABLE 3

| EXAMPLE | COLORATION TIME (sec.) 40% RH 4V T_{clear}/T_{dark}=10 |
|---|---|
| CE-1 | 13.5 |
| CE-2 | 26 |
| CE-3 | 38 |
| EC-1 | 6.5 |
| EC-2 | 4 |
| EC-3 | 3 |
| EC-4 | N/A |

For the processes and/or methods disclosed, the functions performed in the processes and methods may be implemented in differing order, as may be indicated by context. Furthermore, the outlined steps and operations are only provided as examples, and some of the steps and operations may be optional, combined into fewer steps and operations, or expanded into additional steps and operations.

This disclosure may sometimes illustrate components contained within, or connected with, other different components. Such depicted architectures are merely examples, and many other architectures may be implemented which achieve the same or similar functionality.

The terms used in this disclosure, and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.). In addition, if a specific number of elements is introduced, this may be interpreted to mean at least the recited number, as may be indicated by context (e.g., the bare recitation of “two recitations,” without other modifiers, means at least two recitations, or two or more recitations). As used in this disclosure, any disjunctive word and/or phrase presenting two or more alternative terms should be understood to contemplate the possibilities of including one of the terms, either of the terms, or both terms. For example, the phrase “A or B” will be understood to include the possibilities of “A” or “B” or “A and B.”

The terms and words used are not limited to the bibliographical meanings but are merely used to enable a clear and consistent understanding of the disclosure. It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those skilled in the art, may occur in amounts that do not preclude the effect the characteristic was intended to provide.

Aspects of the present disclosure may be embodied in other forms without departing from its spirit or essential characteristics. The described aspects are to be considered in all respects illustrative and not restrictive. The claimed subject matter is indicated by the appended claims rather than by the foregoing description. All changes, which come within the meaning and range of equivalency of the claims, are to be embraced within their scope.

1. A high coloration speed solid-state electrochromic element comprising:
a first electrode layer, wherein the first electrode layer comprises a transparent conductive material;
a first electrochromic layer in electrical communication with the first electrode layer, wherein the first electrochromic layer comprises a p-type or doped p-type electrochromic material;
an insulating layer in electrical communication with the first electrochromic layer, wherein the insulating layer comprises an electrically insulative material or composite with a dielectric constant of at least 10;
a second electrochromic layer in electrical communication with the insulating layer, wherein the second electrochromic layer comprises an n-type electrochromic material; and
a second electrode layer in electrical communication with the second electrochromic layer, wherein the second electrode layer comprises a transparent conductive material.

2. The high coloration speed solid-state electrochromic element of claim 1, wherein the p-type electrochromic material of the first electrochromic layer comprises a metal oxide.

3. The high coloration speed solid-state electrochromic element of claim 2, wherein the metal oxide is nickel oxide.

4. The high coloration speed solid-state electrochromic element of claim 1, wherein the doped p-type electrochromic material of the first electrochromic layer comprises a metal oxide and an inorganic oxide doping material.

5. The high coloration speed solid-state electrochromic element of claim 4, wherein the inorganic oxide doping material comprises at least one selected from the group consisting of aluminum oxide, silicon oxide, titanium oxide and vanadium oxide.

6. The high coloration speed solid-state electrochromic element of claim 4 wherein an atomic ratio of the inorganic oxide doping material to the metal oxide of the doped p-type electrochromic material is 1% to 20%.

7. The high coloration speed solid-state electrochromic element of claim 1, wherein the first electrochromic layer is about 40 nm to about 150 nm thick.

8. The high coloration speed solid-state electrochromic element of claim 1, wherein the electrically insulative material or composite of the insulating layer comprises a metal oxide material with a dielectric constant of at least 10.

9. The high coloration speed solid-state electrochromic element of claim 8, wherein the metal oxide material of the electrically insulative material or composite comprises at least one metal oxide selected from the group consisting of zirconium oxide, hafnium oxide, yttrium oxide and barium titanate.

10. The high coloration speed solid-state electrochromic element of claim 8, wherein the electrically insulative material or composite further comprises an additional inorganic material.

11. The high coloration speed solid-state electrochromic element of claim 10, wherein the additional inorganic material of the electrically insulative material or composite comprises at least one atom selected from the group consisting of aluminum, silicon and titanium.

12. The high coloration speed solid-state electrochromic element of claim 10, wherein an atomic ratio of the inorganic material to the metal oxide material of the electrically insulative material or composite is 1% to 20%.

13. The high coloration speed solid-state electrochromic element of claim 1, wherein the insulating layer is about 10 nm to about 100 nm thick.

14. The high coloration speed solid-state electrochromic element of claim 1, wherein the n-type electrochromic material of the second electrochromic layer comprises tungsten oxide or tungsten oxide doped with an additional inorganic material.

15. The high coloration speed solid-state electrochromic element of claim 1, wherein the second electrochromic layer is about 100 nm to about 300 nm thick.

16. The high coloration speed solid-state electrochromic element of claim 1, wherein the transparent conductive material of the first electrode comprises indium tin oxide; and wherein the transparent conductive material of the second electrode comprises indium tin oxide.

17. The high coloration speed solid-state electrochromic element of claim 1, wherein the first electrode layer or the second electrode layer is about 20 nm to about 400 nm thick.

18. A high coloration speed solid-state electrochromic device comprising:
an electrochemical element of claim 1 ; and
a power source,
wherein the power source is in electrical communication with the first electrode layer and the second electrode layer to provide an electric potential to the device.

19. The high coloration speed solid-state electrochromic device of claim 18, wherein at least one optical property of the electrochromic device may be changed from a first state to a second state upon application of an electric potential; and wherein the electrochromic device is structured so that the second state is maintained without continued application of the electric potential.

20. The high coloration speed solid-state electrochromic device of claim 18, having an electrical potential of about 2 volts to about 6 volts.
